(19) United States
(12) Patent Application Publication
(10) Pub. No.: US 2026/0275037 A1
(43) Pub. Date: Sep. 17, 2026

(54) POLYURETHANE COMPOSITION

(71) Applicant: COATEX, Genay (FR)

(72) Inventors: Antoine BALDIN, Villefranche-Sur-Saone (FR); Guillaume MICHAUD, Lyon (FR); Gaël ROBIN, Sathonay-Camp (FR); Jean-Marc SUAU, Lucenay (FR)

(73) Assignee: COATEX, Genay (FR)

(21) Appl. No.: 19/166,303

(22) PCT Filed: Mar. 28, 2024
(86) PCT No.: PCT/FR2024/000040

§ 371 Date: Sep. 17, 2025

(30) Foreign Application Priority Data
Mar. 31, 2023 (FR) FR2303179

(51) Int. Cl. C08G 71/04; C08K 3/02; C08K 3/04; C08K 3/08; C08K 7/06

(52) U.S. Cl. CPC C08G 71/04; C08K 3/02; C08K 3/042; C08K 3/046; C08K 3/08; C08K 7/06; C08K 2003/023; C08K 2003/0818; C08K 2003/0843; C08K 2003/0856

(57) ABSTRACT

A composition prepared discontinuously by a polymerization reaction of a diisocyanate compound and a polyhydroxylated compound, followed by the termination reaction of the prepolymer of these compounds with a monoalcohol. This composition is mainly urethane polymers with strictly more than 3 residues of the polyhydroxylated compound. Further, the use of this polyurethane composition for bonding active electrode materials to a metal substrate.

The invention relates to a composition discontinuously prepared by a polymerisation reaction of a diisocyanate compound and of a polyhydroxylated compound, followed by the termination reaction of the prepolymer of these compounds with a mono alcohol. This composition comprises a majority of urethane polymers comprising strictly more than 3 residues of the polyhydroxylated compound. The invention also relates to the use of this polyurethane composition to bind active electrode materials to a metal substrate.

Polyurethanes or polymers with urethane groups are widely used in many technical fields that may use different types of rigid or flexible foams, for example, or even in the fields of adhesives, coatings, elastomers, binders, sealants, backing or lacquers. Polyurethane preparation uses two essential reagents to form the polymer chain. The units or residues of these reagents are ultimately present within the structure of the polymer obtained. The ends of the polymer chain can be obtained using a third reagent. The ends of the polymer can in particular be made up of hydrophobic groups, particularly alkyl or alkylene groups, often derived from a mono alcohol, while the polymer chain originates from a polyhydroxylated compound, particularly a polyalkylene glycol, combined with a polyisocyanate monomer, particularly a diisocyanate compound.

These polyurethanes are prepared by step-growth polymerisation using a mechanism of independent steps based on the reactivity of functional groups that react together to form a new group that will chemically bind the respective chain ends by polyadditions. The monomers which are at least bifunctional, particularly the diisocyanates and the diols, react and form prepolymers which can then react with a compound carrying the terminal group, for example a mono alcohol. Controlling the reaction conditions for preparing the prepolymer and then reacting the mono alcohol is important and should make it possible to obtain urethane polymers with properties suited to the various fields of use. It is particularly useful to be able to control the respective amounts of the various urethane polymers resulting from these preparation methods, in particular to be able to facilitate the obtention of certain polyurethanes, particularly in relation to the high proportion of diol residues present within the polymer.

It is also very useful to be able to control the production of urethane polymers comprising a high relative amount of urethane groups compared to the molecular mass of the polyurethane obtained. The density of urethane groups in the polymer can therefore be increased.

Since the polyisocyanate monomer comprises a hydrocarbon chain, the urethane polymer can therefore also comprise a significant proportion of hydrocarbon residues within the polymer chain.

In addition to the advantages directly linked to their preparation, particularly in terms of yield or of orientation towards the preferred urethane polymers, better control of the polyurethane preparation conditions must also make it possible to achieve the desired properties, particularly according to the field of use.

For example, for the preparation of secondary batteries, there are known electrode compositions that generally comprise carbon or a metal in the form of particles combined with a binding composition. This binding composition must be able to effectively bind the carbon or the metal to a substrate to form an electrode. The most common binding compositions comprise a styrene-butadiene polymer for anode compositions or a polyvinylidene fluoride for cathode compositions, and make it possible to attach active particles to a metal substrate. Binding properties, mechanical strength or electrochemical resistance are particularly important when producing and using an electrode. Indeed, the quality of the electrode composition coating applied to the metal substrate is essential to the optimum efficacy of the electrode as well as to its maximum durability.

Generally, binding compositions also comprise various additives such as thickening agents, dispersing agents, for example a cellulose derivative. The most common cellulose derivatives are carboxymethylcellulose, hydroxyethyl cellulose and hydroxy methylcellulose.

Moreover, it should be possible to reduce the number of ingredients used when preparing electrode compositions. The compatibility of the different ingredients of the electrode compositions is also an important factor when preparing electrode compositions as well as when preparing electrodes using these compositions.

The thixotropic behaviour or rheological behaviour over time of an aqueous electrode composition must therefore be controlled to the extent possible.

It is also advantageous to have versatile electrode compositions that retain their rheological properties when used under different conditions.

Easy, uniform application of electrode compositions is necessary in order to obtain a uniform coat and to limit or avoid flaws on the surface of the electrode, resulting in a uniform and particularly effective conductive coat. Surface levelling, restructuring and flow behaviour of an aqueous electrode composition must be well controlled.

It is therefore essential to be able to provide electrode compositions with a very well controlled rheology. Indeed, in addition to application issues, excessive viscosity generally leads to numerous flaws in the coat deposited on the surface of the electrode. Insufficient viscosity results in the same types of problems and also leads to uncontrolled flows of the electrode composition during its application.

Electrode compositions must also be stable and homogenous during their preparation, storage or application. Settling, cluster or aggregate formation and ingredient separation must therefore be limited or avoided.

Anode compositions frequently comprise silicon in order to increase the capacity of the prepared anodes. During the charging-discharging cycles of the batteries containing these anodes, it is usual to observe a strain that can lead to irreversible alteration of the anode, particularly as a result of the increase in the volume of the silicon. Strain tolerance is therefore also a desirable property.

Document JP 2015220170 describes the preparation of an anode for a battery with a polymer binder made of thermoplastic resin prepared using poly(tetramethylene glycol), diethylene glycol, IPDI and N,N′-dimethylformamide. Documents EP 2444432 and

EP 1940978 describe the preparation of polyurethanes from triisocyanate compounds or triols.

The electrode compositions in the prior art are not always satisfactory. There is thus a need for electrode compositions that provide solutions to all or part of the problems of the electrode compositions in the prior art.

There is also a need for improved compositions of urethane polymers and methods of preparing them that provide solutions to some or all of the problems of the compositions of urethane polymers and methods of preparing them in the prior art.

Thus, the invention provides a non-aqueous composition C comprising urethane polymers and discontinuously prepared:
by a polymerisation reaction, in the absence of any monohydroxyl compound:
   of at least one diisocyanate compound (a),
   of at least one polyhydroxylated compound (b), followed by:
the termination reaction of the prepolymer of the compounds (a) and (b) with at least one compound (c) of formula I:

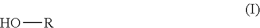

wherein R independently represents a group chosen among a straight C₁-C₄₀-alkyl group, a branched C₃-C₄₀-alkyl group, a C₅-C₄₀-cycloalkyl group, a straight C₃-C₄₀-alkylene group, a branched C₃-C₄₀-alkylene group, a C₅-C₄₀-aryl group and combinations thereof;

wherein the urethane polymers strictly comprising more than 3 residues of compound (b) are in the majority by number measured by SEC.

When preparing the composition C according to the invention, the difunctional compounds (a) and (b) react, by addition of the isocyanate groups of the compound (a) and of the hydroxyl groups of the compound (b), to form prepolymers comprising chemical residues or chemical units derived from these two compounds. Several compounds (a) can react with several compounds (b) to form prepolymers comprising several urethane groups. The termination reaction of these prepolymers with the compound (c) results in the presence of two residues of the compound (c) in the urethane polymers of the composition C according to the invention.

Lastly, for 2 residues of the compound (c), the urethane polymers according to the invention comprising a number 2N of residues of the compound (b) comprise a number N+1 of hydrocarbon residues of the compound (a) and a number 2N+2 of urethane groups. According to the invention, the value of N is greater than 3.

Preferably according to the invention, the urethane polymers comprise strictly more than three residues of the compound (b) represent at least 40% by number, preferably at least 50% by number or at least 55% by number, more preferentially at least 60% by number or at least 65% by number or at least 70% by number, of all of the urethane polymers.

According to the invention, the distribution of the polymeric entities present in the urethane polymers of the compound C according to the invention, in particular the proportions by number of the residues of the compound (b) present in the polymers, is determined by high-performance Size Exclusion Chromatography (SEC), preferably using high-performance size exclusion chromatograph (“Acquity” Advanced Polymer Chromatography APC by “Waters”) with refractometric detector and column system consisting of 3 “Waters” columns in series: “Acquity” APC XT 900 2.5 μm 4.6 mm×150 mm, “Acquity” APC XT 450 2.5 μm 4.6 mm×150 mm and “Acquity” APC XT 125 2.5 μm 4.6 mm×150 mm. The solvent used for the mobile phase is tetrahydrofuran (HPLC grade THF). Calibration is carried out using polymethyl methacrylate (PMMA) standards with a molecular mass ranging up to 2,200,000 g/mol. The samples of composition C according to the invention being dissolved in THF.

Also preferably according to the invention, the urethane polymers have a molar mass Mw, measured by SEC, greater than 20,000 g/mol, preferably greater than 30,000 g/mol, or a molar mass Mw of less than 500,000 g/mol, preferably less than 300,000 g/mol. More preferably according to the invention, the urethane polymers have a molar mass Mw, measured by SEC, ranging from 20,000 g/mol to 500,000 g/mol, preferably from 30,000 g/mol to 300,000 g/mol.

Also preferably according to the invention, the urethane polymers have a polymolecularity index PI, measured by SEC, of less than 4 or less than 3. More preferably according to the invention, this polymolecularity index is less than 2. Also preferably according to the invention, the urethane polymers have a polymolecularity index PI greater than 1.3. According to the invention, the molecular weight or mass and the polymolecularity index are determined by Size Exclusion Chromatography (SEC). A test portion of the compound solution corresponding to 90 mg of dry solids content is introduced into a 10 mL bottle. Mobile phase is added, together with 0.04% of dimethylformamide (DMF), until a total mass of 10 g is reached. The composition of this mobile phase is as follows: NaHCO₃:0.05 mol/L, NaNO₃:0.1 mol/L, triethanolamine: 0.02 mol/L, NaN₃ 0.03% by mass. The SEC chain is composed of a “Waters” 510 isocratic pump with a flow rate set to 0.8 mL/min, of a “Waters” 717+sample changer, of an oven containing a “Waters” Ultrahydrogel Column Guard precolumn 6 cm long and 40 mm in inner diameter, followed by a “Waters” Ultrahydrogel linear column 30 cm long and 7.8 mm in inner diameter. Detection is provided by means of a “Waters” 410 RI differential refractometer. The oven is brought to a temperature of 60° C. and the refractometer is brought to a temperature of 45° C. The SEC instrument is calibrated with a series of polyacrylate sodium standards supplied by Polymer Standards Service with a molecular weight at the top of the peak comprised between 900 g/mol and 2,250,000 g/mol and a polymolecularity index comprised between 1.4 and 1.7. The calibration curve is straight-line and takes into account the correction obtained using the flow rate marker: dimethylformamide (DMF).

Acquisition and processing of the chromatogram are performed using “PSS WinGPC Scientific” software v 4.02. The chromatogram obtained is incorporated into the area corresponding to molecular weights of more than 250 g/mol.

Preferably for the composition C according to the invention, the diisocyanate compound (a) is chosen among:
the symmetric aromatic diisocyanate compounds, preferably:
   2,2′-diphenylmethylene diisocyanate (2,2′-MDI) and 4,4′-diphenylmethylene diisocyanate (4,4′-MDI);
   4,4′-dibenzyl diisocyanate (4,4′-DBDI);
   2,6-toluene diisocyanate (2,6-TDI);
   m-xylylene diisocyanate (m-XDI);
the symmetric alicyclic diisocyanate compounds, preferably methylene bis(4-cyclohexylisocyanate) (H12MDI);
the symmetric aliphatic diisocyanate compounds, preferably hexamethylene diisocyanate (HDI), pentamethylene diisocyanate (PDI);
the asymmetric aromatic diisocyanate compounds, preferably:
   2,4′-diphenylmethylene diisocyanate (2,4′-MDI);
   2,4′-dibenzyl diisocyanate (2,4′-DBDI);
   2,4-toluene diisocyanate (2,4-TDI);
the asymmetric alicyclic diisocyanate compounds, preferably isophorone diisocyanate (IPDI).

More preferably, the compound (a) is chosen among IPDI, HDI, H12MDI and combinations thereof. Also preferably according to the invention, the composition C does not comprise urethane polymers prepared in the presence of a branched polyisocyanate compound comprising at least 3 isocyanate groups. In particular, the rheology control agent G does not comprise urethane polymers prepared in the presence of cyanurate trimer compound or of biuret trimer, in particular in the absence of HDI isocyanurate trimer or IPDI isocyanurate trimer.

Preferentially according to the invention, the compound (b) is a dihydroxylated compound, more preferentially a diol. Preferably for the composition C according to the invention, the polyhydroxylated compound (b) is a compound of formula II:

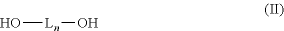

wherein:
L independently represents an oxyalkylene residue;
n independently represents a number ranging from 10 to 500.

Preferably for the composition C according to the invention, the polyhydroxylated compound (b) is a compound of formula II wherein L independently represents an oxyethylene residue.

Also preferably for the composition C according to the invention, the polyhydroxylated compound (b) is a compound of formula II wherein n independently represents a number ranging from 10 to 400, preferably from 10 to 150. More preferably for the composition C according to the invention, the polyhydroxylated compound (b) is a compound of formula II wherein L independently represents an oxyethylene residue and n independently represents a number ranging from 25 to 400, preferably from 30 to 300.

Also preferably for the composition C according to the invention, the compound (b) has a molar mass (Mw), measured by SEC, ranging from 800 to 15,000 g/mol, preferably from 800 g/mol to 12,000 g/mol or from 800 g/mol to 10,000 g/mol. More preferentially the compound (b) has a molar mass Mw ranging from 1,000 g/mol to 8,000 g/mol or from 1,000 g/mol to 6,000 g/mol.

Preferably for the composition C according to the invention, the compound (c) is a compound of formula I wherein R independently represents a group chosen among a straight C₁-C₃₂-alkyl group, a branched C₃-C₃₂-alkyl group, a C₅-C₃₂-cycloalkyl group, a straight C₃-C₃₂-alkylene group, a branched C₃-C₃₂-alkylene group, a C₅-C₃₂-aryl group and combinations thereof.

More preferably for the composition C according to the invention, the compound (c) is a compound of formula I wherein R independently represents a group chosen among a straight C₁-C₂₄-alkyl group or a straight C₃-C₂₄-alkylene group, preferably a straight C₄-C₂₀-alkyl group or a straight C₄-C₂₀-alkylene group, more preferentially a straight C₆-C₁₈-alkyl group or a straight C₆-C₁₈-alkylene group, much more preferentially a straight C₆-C₁₆-alkyl group or a straight C₆-C₁₆-alkylene group.

According to the invention, the compound (c) can be different from n-decanol, from a branched C₁₂-C₁₃ primary alcohol, from a branched C₁₄-C₁₅ primary alcohol, from 2-octyldodecanol.

Advantageously, when preparing urethane polymers according to the invention, the respective amounts of the compounds (a), (b) and (c) used can vary. Preferably for the composition C according to the invention, the polymerisation reaction uses:
from 10 to 79.9 mol % or from 10 to 74.5 mol %, preferably from 10 to 68 mol % or from 10 to 60 mol %, of monomer (a) or
from 20 to 89.9 mol % or from 25 to 89.5 mol %, preferably from 30 to 88 mol % or from 35 to 85 mol %, of monomer (b) or
from 0.1 to 70 mol % or from 0.5 to 65 mol %, preferably from 2 to 60 mol % or from 5 to 55 mol %, of monomer (c), relative to the total molar amount of monomers (a), (b) and (c).

More preferably for the composition C according to the invention, the polymerisation reaction uses:
1 from 10 to 79.9 mol % or from 10 to 74.5 mol %, preferably from 10 to 68 mol % or from 10 to 60 mol %, of monomer (a),
from 20 to 89.9 mol % or from 25 to 89.5 mol %, preferably from 30 to 88 mol % or from 35 to 85 mol %, of monomer (b) and
from 0.1 to 70 mol % or from 0.5 to 65 mol %, preferably from 2 to 60 mol % or from 5 to 55 mol %, of monomer (c), relative to the total molar amount of monomers (a), (b) and (c).

When preparing urethane polymers according to the invention, the relative amounts of the compounds (a) and (b) used can vary. Preferably for the composition C according to the invention, the polymerisation reaction uses molar amounts of diisocyanate compound (a) and of polyhydroxylated compound (b) in an a/b molar ratio ranging from 1.05 to 3.

More preferably for the composition C according to the invention, the polymerisation reaction uses molar amounts of diisocyanate compound (a) and of polyhydroxylated compound (b) in an a/b molar ratio ranging from 1.1 to 2 or from 1.1 to 1.5. Much more preferentially, this a/b molar ratio ranges from 1.1 to 1.45 or from 1.1 to 1.4.

Essentially according to the invention, the composition C comprises urethane polymers which comprise strictly more than 3 residues of compound (b) are in the majority by number measured by SEC. Preferably for the composition C according to the invention, the urethane polymers strictly comprising more than 4 residues, preferably more than 5 residues or more than 6 residues, of compound (b) are in the majority by number measured by SEC.

Essentially according to the invention, the composition C according to the invention is prepared according to a method comprising a polymerisation reaction, in the absence of any monohydroxyl compound, followed by a termination reaction. Thus, the invention provides a method of discontinuously preparing a composition C according to the invention comprising:
a polymerisation reaction, in the absence of any monohydroxyl compound:
   of at least one diisocyanate compound (a),
   of at least one polyhydroxylated compound (b), followed by:
the termination reaction of the prepolymer of the compounds (a) and (b) with at least one compound (c) of formula I:

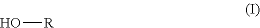

wherein R independently represents a group chosen among a straight C₁-C₄₀-alkyl group, a branched C₃-C₄₀-alkyl group, a C₅-C₄₀-cycloalkyl group, a straight C₃-C₄₀-alkylene group, a branched C₃-C₄₀-alkylene group, a C₅-C₄₀-aryl group and combinations thereof;

wherein the urethane polymers strictly comprising more than 3 residues of compound (b) are in the majority by number measured by SEC.

Preferably for the preparation method according to the invention, the polymerisation reaction is carried out in the polyhydroxylated compound (b), preferably in the melt medium of compound (b). In particular, the polymerisation reaction is carried out in the absence of any organic solvent, preferably in the absence of any organic hydrocarbon solvent such as xylene or toluene.

Also preferably for the preparation method according to the invention, the polymerisation reaction uses molar amounts of diisocyanate compound (a) and of polyhydroxylated compound (b) in an a/b molar ratio ranging from 1.05 to 3. More preferentially, this a/b molar ratio ranges from 1.1 to 2 or from 1.1 to 1.5. Much more preferentially, this a/b molar ratio ranges from 1.1 to 1.45 or from 1.1 to 1.4.

Also preferably for the preparation method according to the invention, the polymerisation reaction is carried out for 10 min to 60 min, more preferentially 10 min to 30 min, depending in particular on compounds (a) and (b) or on the catalyst.

The preparation method according to the invention makes it possible to prepare particular urethane polymers. Thus, the invention provides a urethane polymer P prepared according to the method defined according to the invention and which comprises strictly more than 3, preferably strictly more than 4 or strictly more than 5, more preferentially strictly more than 6, residues of compound (b).

The urethane polymers according to the invention and the composition C according to the invention can be used in many technical fields. Preferably, the urethane polymers according to the invention and the composition C according to the invention can be used when preparing an electrode preparation composition T. Preferably, the urethane polymers according to the invention and the composition C according to the invention can be used in a binding agent of an active electrode material. Thus, the invention provides a composition T for preparing an electrode comprising:
at least one material E chosen among:
   at least one anode material E1 chosen among metal fibres, metal particles, carbon graphite fibres, carbon graphite particles, silicon particles and combinations thereof;
   at least one cathode material E2 comprising carbon particles;
   at least one electroactive cathode material E3;
at least one binding agent L of material E comprising at least one composition C according to the invention;
a liquid carrier.

The invention also provides an electrode preparation composition T comprising:
at least one material E chosen among:
   at least one anode material E1 chosen among metal fibres, metal particles, carbon graphite fibres, carbon graphite particles, silicon particles and combinations thereof;
   at least one cathode material E2 comprising carbon particles;
   at least one electroactive cathode material E3;
at least one binding agent L of material E comprising urethane polymers P according to the invention;
a liquid carrier.

The invention therefore provides a composition T according to the invention, which is an aqueous anode preparation composition comprising:
at least one anode material E1 chosen among metal fibres, metal particles, carbon graphite fibres, carbon graphite particles, silicon particles and combinations thereof;
at least one binding agent L of material E comprising urethane polymers P according to the invention or at least one composition C according to the invention;
a liquid carrier, preferably water.

The invention also provides a composition T according to the invention, which is a non-aqueous cathode preparation composition comprising:
at least one cathode material E2 comprising carbon particles;
at least one electroactive cathode material E3;
at least one binding agent L of materials E2 and E3 comprising urethane polymers P according to the invention or at least one composition C according to the invention or at least one polymer according to the invention;
a liquid carrier, preferably a polar aprotic organic solvent, preferably chosen among pyrrolidone, N-methyl-pyrrolidone (NMP), alkyl carbonates and combinations thereof.

Preferably according to the invention, the electrode preparation composition according to the invention can be an anode preparation composition; the material E1 is then chosen among silicon, carbon graphite or graphitic carbon, hexagonal carbon, rhombohedral carbon and combinations thereof, optionally doped with at least one element, preferably chosen among lithium, silicon, germanium and combinations thereof. Preferably, the material E1 is in the form of particles, preferably particles with a volume-average size, measured by dynamic light scattering (DLS), of less than 200 μm, preferably less than 150 μm or less than 100 μm, or which ranges from 50 μm to 200 μm.

Also preferably according to the invention, the electrode preparation composition according to the invention can be a cathode preparation composition; the material E2 is then chosen among carbon black, acetylene black, Ketjen black, carbon fibres, carbon nanotubes, carbon nanofibre, graphene and combinations thereof. And the electroactive material E3 is then chosen among lithium, iron, nickel, manganese, cobalt and combinations thereof, preferably chosen among iron, nickel, manganese, cobalt and combinations thereof, preferably chosen among LiFePO, (LFP), Li(Ni,Mn,Co) O. (NMC) and combinations thereof.

In addition to the binding agent L, the electrode preparation composition according to the invention can comprise one or more other binding agents. In this case, the composition T according to the invention also comprises at least one additional binding agent, preferably chosen among an anode binding polymer LI in the form of a water-insoluble latex, preferably chosen among a styrene-butadiene rubber (SBR) polymer, phenyl-propane latex, ethylene/ethylene-acetate (EVA) copolymer, acrylic latex, methacrylic latex, acrylonitrile latex, polymethyl methacrylate, water-insoluble ASE polymer latex, water-insoluble HASE polymer latex and combinations thereof.

The polymer L1 is preferentially a styrene-butadiene polymer.

The composition T according to the invention can also comprise a water-soluble anode binding polymer L2, preferably chosen among a water-soluble ASE polymer, a water-soluble HASE polymer, a water-soluble acrylic polymer, polyvinyl alcohol (PVA), poly(ethylene oxide) (PEO), carboxymethyl cellulose (CMC), sodium polyacrylate, modified polyacrylic acid, acrylamide homopolymer, acrylamide copolymer and combinations thereof. Preferably, the water-soluble polymer L2 is prepared by at least one emulsion polymerisation reaction with a water-soluble anionic monomer. The polymer L2 is preferentially an acrylic latex. Preferably, the water-soluble polymer L2 has a weight-average molecular mass Mw (measured by SEC) of less than 1,000,000 g/mol, preferably less than 800,000 g/mol or less than 500,000 g/mol, more preferentially less than 100,000 g/mol or less than 50,000 g/mol. Also preferably, the water-soluble polymer L2 has a weight-average molecular mass Mw (measured by SEC) greater than 2,000 g/mol or greater than 5,000 g/mol.

Preferably according to the invention, the water-soluble polymer L2 is prepared in the presence of at least one initiator compound, by a polymerisation reaction of at least one anionic monomer M1 chosen among acrylic acid, methacrylic acid, an acrylic acid oligomer, an acrylic acid salt, a methacrylic acid salt and combinations thereof, and optionally of at least one monomer different from the monomer M1.

Preferably according to the invention, this other monomer, different from monomer M1, is independently chosen among:
an anionic monomer M2, different from the anionic monomer MI, chosen among maleic acid, a maleic acid salt, itaconic acid, an itaconic acid salt, crotonic acid, a crotonic acid salt and combinations thereof,
an organosulphur monomer M3, preferably a monomer M3 chosen among a sulphonated monomer M3a, a sulphated monomer M3b, and combinations thereof, more preferentially an organosulphur monomer M3 chosen among 2-acrylamido-2-methylpropane sulphonic acid (AMPS), allyl sulphonic acid, alkylenesulphonates, alkylenearylsulphonates, in particular styrene sulphonate, vinyl sulphonate, methallyl sulphonate, allyl sulphonate, methallyl sulphate, allyl sulphate, 2-sulphoethyl methacrylate, 3-allyloxy-2-hydroxy-1-propanesulphonic acid, 3 sulphopropyl methacrylate, their salts and combinations thereof, a non-ionic monomer M4 chosen among vinyl acetate, a C₁-C₈ ester of a compound derived from an acid chosen among acrylic acid, methacrylic acid, maleic acid, itaconic acid and crotonic acid, (for example ethyl methacrylate, methyl methacrylate, butyl methacrylate, ethyl acrylate, methyl acrylate, butyl acrylate), hydroxyethyl methacrylate, hydroxyethyl acrylate, hydroxypropyl methacrylate, hydroxypropyl acrylate, a nitrogenous monomer (for example acrylonitrile, methacrylamide, acrylamide, vinyl lactam, N-methylol acrylamide), styrene and combinations thereof,
a cross-linking monomer M5, preferably a monomer M5 comprising at least 2 polymerisable ethylenic groups, preferably a monomer M5 chosen among the polyvinyl aromatic monomers (for example divinylbenzene and diallyl phthalate); polyalkenyl ethers (triallyl pentaerythritol, diallyl pentaerythritol, diallyl sucrose, octa allyl sucrose, trimethylolpropane diallyl ether); polyunsaturated esters of polyalcohols or polyunsaturated esters of polyacids (for example trimethylolpropane tri(meth)acrylate, trimethylolpropane, polyethylene glycol di(meth) acrylates); diacrylic esters, dimethacrylic esters derived from polyols chosen in particular among pentaerythritol, sorbitol, sucrose; divinyl naphthalene, trivinylbenzene, 1,2,4-trivinylcyclohexane, triallyl pentaerythritol, diallyl pentaerythritol, diallyl sucrose, trimethylolpropane diallyl ether, 1,6-hexanediol di(meth) acrylate, allyl(meth)acrylate, diallyl itaconate, diallyl fumarate, diallyl maleate, butanediol dimethacrylate, ethylene di(meth) acrylate, poly(ethylene glycol)di(meth) acrylate, trimethylolpropane tri(meth)acrylate, methylenebis(meth)acrylamide, triallylcyanurates, diallyl phthalate, divinylbenzene; diallyl phthalate (DAP); ethylene glycol dimethacrylate (EGDMA); methylene bis acrylamide (MBA); divinylbenzene (DVB); bicyclopentenyloxyethyl-methacrylate (FRA); trimethylol propane triallyl ether (APE) and combinations thereof.

Preferably, the polymer L2 is prepared using:
from 2% by weight to 100% by weight, preferably from 5% by weight to 98% by weight, of at least one monomer M1, and
from 0 to 98% by weight, preferably from 2% by weight to 95% by weight, relative to the total amount by weight of monomers, of at least one other monomer, different from monomer MI, preferably of at least one other monomer chosen among monomer M2, monomer M3, monomer M4, monomer M5 and combinations thereof.

According to the invention, the composition T can also comprise an anode binding polymer L3 chosen among cellulose, in particular carboxy methylcellulose (CMC), hydroxycellulose (in particular hydroxymethylcellulose or hydroxyethylcellulose), alginate, poly(allylamine, HCl), pectin, amylopectin, guar gum and combinations thereof. It can also comprise a cathode binding agent L4 chosen among polyvinylidene fluoride (PVDF) and combinations thereof, preferably PVDF.

Preferably according to the invention, the binding compound is not a (meth)acrylic polymer.

The anode composition T according to the invention can also comprise at least one organic acid or one mineral acid, preferably an acid chosen among sulphuric acid, phosphoric acid, phosphorous acid, hypophosphorous acid, acetic acid, lactic acid and combinations thereof.

The amounts of the various ingredients in the composition T according to the invention can vary. Preferably, the composition T according to the invention comprises:
from 85% by dry weight to 99.5% by dry weight of material E,
from 0.5% by dry weight to 15% by dry weight of binding agent, in particular of binding agent L,

relative to the total amount by dry weight of binding agent, in particular of binding agent L, and of material E.

Also preferably, the composition T according to the invention comprises:
from 70% by dry weight to 99.5% by dry weight of material E,
from 0.3% by dry weight to 10% by dry weight of binding agent, in particular of binding agent L,
from 0.2% by weight to 10% by weight of liquid carrier, relative to the total amount by dry weight of material E and of binding agent, in particular of binding agent L, and of liquid carrier.

The invention also provides a method for preparing a composition T according to the invention, comprising the preparation of a binding agent L and the addition of at least one material E and of the liquid carrier.

The composition T according to the invention can be used to produce an electrode.

Thus, the invention provides a method for producing an anode comprising:
applying at least one anode composition T according to the invention to a substrate, preferably a metal substrate chosen among copper, titanium, silver, zinc, nickel and combinations thereof, more preferentially a copper substrate,
drying and then calendering the coated substrate.

More preferably for the anode production method according to the invention, the application is carried out at a pH of less than 7 or at a pH ranging from 4 to 6.5. Also more preferably for the anode production method according to the invention, the anode composition T is applied to the substrate at a thickness, after drying and calendering, measured using a 1 μm to 1,000 μm coating thickness gauge, that is less than 500 μm, preferably less than 100 μm or less than 20 μm.

Also more preferably for the anode production method according to the invention, the anode composition T is applied to the substrate at a thickness, after drying and calendering, measured using a 1 μm to 1,000 μm coating thickness gauge, that is greater than 5 μm. Also more preferably for the anode production method according to the invention, the anode composition T is uniformly applied to the substrate, preferably the anode composition T is uniformly applied to the substrate according to the visual inspection method used in the examples.

The invention also provides an anode produced according to the production method according to the invention.

The invention also provides a method for producing a cathode comprising:
applying at least one aqueous composition T according to the invention to a metal substrate, in particular a metal substrate comprising aluminium,
drying and then calendering the metal substrate coated with the composition T.

More preferably for the cathode production method according to the invention:
the substrate is a purely metallic substrate or a composite substrate comprising at least one metal and at least one insulating substrate; or
the electroactive compound is chosen among lithium, iron, nickel, manganese, cobalt and combinations thereof.

The invention also provides a cathode produced according to the production method according to the invention.

The advantageous, particular or preferred characteristics of the composition C according to the invention define urethane polymers, compositions T, preparation methods or producing methods according to the invention, as well as anodes or cathodes, that are also advantageous, particular or preferred.

The various aspects of the invention can be illustrated by examples.

### EXAMPLES

Preparation and characterisation of urethane polymer compositions C1 to C8 according to the invention:

The following compounds a, b and c are used in the preparation of urethane polymers:
compound a1: H12MDI diisocyanate,
compound a2: HDI diisocyanate,
compound a3: IPDI diisocyanate,
compound b1: polyethylene glycol with a molecular mass of 2,000 g/mol,
compound b2: polyethylene glycol with a molecular mass of 4,000 g/mol,
compound b3: polyethylene glycol with a molecular mass of 5,500 g/mol,
compound b4: polyethylene glycol with a molecular mass of 8,000 g/mol,
compound b5: polyethylene glycol with a molecular mass of 10,000 g/mol,
compound c1: hydrophobic mono alcohol of formula I wherein R represents a straight C₆-alkyl group,
compound c2: hydrophobic mono alcohol of formula I wherein R represents a straight C₁₂-alkyl group,
compound c3: hydrophobic mono alcohol of formula I wherein R represents branched C₂₄-C₂₆ alkyl groups derived from a Guerbet alcohol (“Isofol” 2426S by “Sasol”),

### Compositions C1 to C8 According to the Invention:

In a 2 L reactor equipped with mechanical stirring, the compound (b1) (polyethylene glyco—molecular mass 2,000 g/mol) (163.9 g) is introduced and heated to 90° C. 0.20 g of a bismuth catalyst (K-KAT XC-B221 by “King Industries”) is added then a diisocyanate compound (a1) (H12MDI, 25.8 g) is introduced. The reaction medium is stirred continuously for 30 minutes (reaction time, RT) at 95° C. to form the prepolymer. The compound (c1) is then added. The reaction is continued at 95° C. for 30 minutes under stirring.

Compositions C₂ to C₈ according to the invention are prepared in a manner similar to the preparation of composition C₁. The compounds and amounts (g) used and the reaction times TR are shown in Table 1.

TABLE 1

| | Compounds (g) | | | | | TR |
|---|---|---|---|---|---|---|
| Composition | a | | b | c | | (min) |
| C1 | a1 | (25.8) | b1 (163.9) | c1 | (11.2) | 30 |
| C2 | a1 | (15.3) | b2 (178.9) | c1 | (6.6) | 15 |
| C3 | a1 | (12.2) | b3 (183.3) | c1 | (5.3) | 10 |
| C4 | a1 | (7.0) | b5 (190.5) | c1 | (3.4) | 10 |
| C5 | a2 | (8.0) | b3 (186.9) | c1 | (6.0) | 15 |
| C6 | a3 | (10.2) | b3 (184.8) | c1 | (5.8) | 15 |
| C7 | a1 | (11.9) | b3 (178.5) | c2 | (10.4) | 15 |
| C8 | a1 | (12.9) | b3 (193.7) | c3 | (22.2) | 15 |

Compositions C1 to C8 according to the invention are characterised by high-performance size exclusion chromatography. The molecular masses of the urethane polymer mixtures present in compositions C1 to C8 according to the invention are measured using a high-performance size exclusion chromatograph (“Acquity” Advanced Polymer Chromatography APC by “Waters”) with a refractometric detector. The column system used consists of 3 “Waters” columns in series:
“Acquity” APC XT 900 2.5 μm 4.6 mm×150 mm,
“Acquity” APCXT 450 2.5 μm 4.6 mm×150 mm and
“Acquity” APC XT 125 2.5 μm 4.6 mm×150 mm.

The solvent used for the mobile phase is tetrahydrofuran (HPLC grade THF). Calibration is carried out using polymethyl methacrylate (PMMA) standards with a molecular mass ranging up to 2,200,000 g/mol. The samples of polymers P according to the invention are dissolved in THF.

The analysis makes it possible to determine the average molecular masses in number Mn and in mass Mw (g/mol) of the urethane polymers of the compositions according to the invention. The polydispersity PI and the degree of polymerisation are also evaluated by differentiating the molecular weights of the different polymeric entities present in the samples of compositions according to the invention. The distribution of the polymeric entities is quantified in each sample, in particular the number proportions of the PEG residues present in the polymers. The results obtained for the urethane polymer samples present in compositions C1 to C8 according to the invention are shown in table 2.

TABLE 2

| | Number of PEG units (%) | | | | |
|---|---|---|---|---|---|
| Composition | 2 or less | 3 | 4 or more | Mw | PI |
| C1 | 2 | 2 | 96 | 76,790 | 2.00 |
| C2 | 3 | 4 | 93 | 95,330 | 1.89 |
| C3 | 16 | 12 | 72 | 68,790 | 1.57 |
| C4 | 36 | 12 | 52 | 75,410 | 1.88 |
| C5 | 22 | 11 | 67 | 58,755 | 1.84 |
| C6 | 27 | 14 | 59 | 49,520 | 1.75 |
| C7 | 31 | 13 | 56 | 48,625 | 1.74 |
| C8 | 6 | 11 | 83 | 81,135 | 1.78 |

Compositions C1 to C8 according to the invention comprise a majority of urethane polymers comprising strictly more than 3 PEG residues.

In addition, the composition C1 of urethane polymers according to the invention is formulated by mixing it in water at a concentration of 20% by mass and of 80% by mass of water. Similarly, aqueous formulations are prepared with the compositions C2 a C₈ according to the invention. Composition C₈ according to the invention is formulated (17.5% by mass) in water (69.2% by mass) in the presence of a surfactant compound (“Emulan” HE51 by “Basf”, polyethoxylated alcohol, 13.3% by mass).

Using an analogue viscometer equipped with a spindle, the Brookfield viscosity (mPa·s) of these aqueous formulations comprising compositions C₁ to C₈ is measured at 10 rpm after storage for 24 hours at 25° C. The results obtained are shown in Table 3.

TABLE 3

| Composition | Brookfield Viscosity | Spindle size |
|---|---|---|
| C1 | 3,040 | 6 |
| C2 | 7,900 | 6 |
| C3 | 2,840 | 5 |
| C4 | 14,100 | 6 |
| C5 | 600 | 5 |
| C6 | 200 | 4 |
| C7 | >50,000 | 7 |
| C8 | 2,960 | 5 |

Compositions C₁ to C₈ according to the invention, in which urethane polymers strictly comprising more than 3 PEG residues are in the majority by number, make it possible to effectively control aqueous compositions.

### Preparation of Aqueous Anode Compositions T1 to T3 According to the Invention:

43 g of water and 2.1 g of a polyacrylic acid dispersing agent (molecular mass 600,000 g/mol measured by SEC) are introduced into a 500-mL polypropylene container suitable for a stirrer (“Speedmixer” DAC 1100), then mixed for 1 minute at 800 rpm. 50 g of material E (synthetic D50 graphite powder 15-19 μm-“S360”) are added and the mixture is mixed for 1 minute and 30 seconds at 1,600 rpm. The pH is adjusted to a pH of 6 using a 95% by dry weight aqueous solution of AMP (2-amino-2-methyl-1-propanol). This is stirred for 1 minute at 1,600 rpm. 5.8 g of composition C₁ according to the invention are added and the mixture is mixed for 1 minute at 1,600 rpm. 1.6 g of styrene-butadiene latex (BM 451B “Zeon”) is added and the mixture is mixed for 1 minute at 800 rpm. This results in the anode composition T1 according to the invention.

Similarly, the aqueous anode compositions T2 and T3 are prepared by respectively replacing composition C1 with compositions C2 (5.6 g) and C3 (5.3 g) and using 44 g water.

### Preparation and Characterisation of Anodes According to the Invention:

A 12-μm-thick copper foil is coated with a 200-μm wet coat of aqueous anode composition T1 according to the invention using a 4-hole manual applicator on a vacuum application table at a speed of 10 mm/s. The coated foil is then dried for 24 hours in a climate-controlled chamber at a temperature of 25° C. and a humidity of 50%. Once dry, the coated foil is calendered on both sides at a pressure of 25 kg/cm² and a speed of 0.1 m/s using a calender machine (“Gester”). Discs with a diameter of 12 mm are cut out using a precision cutter.

Similarly, an anode is prepared by replacing the aqueous anode composition T1 with the composition T2 and T3 according to the invention.

After preparation, the uniformity and adhesion of the coat of composition T are assessed by visual inspection of the prepared anodes: no aggregate or surface heterogeneity is visible on the surface of the coat when viewed from the front in daylight. The coat has no adhesion flaws.

Compositions C₁ to C₃ according to the invention, in which the urethane polymers comprising strictly more than 3 PEG residues are in the majority in number, make it possible to prepare an anode with an even, uniform and stable active surface.

1. A non-aqueous composition C, comprising:
a urethane polymer,
wherein the non-aqueous composition C is discontinuously prepared by a process comprising:
polymerizing, in the absence of any monohydroxyl compound, monomers comprising a diisocyanate compound (a) and polyhydroxylated compound (b), to obtain a prepolymer; followed by
terminating the prepolymer with a terminator comprising a compound (c) of formula (I): 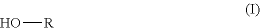
wherein R is independently a straight C₁-C₄₀-alkyl group, a branched C₃-C₄₀-alkyl group, a C₅-C₄₀-cycloalkyl group, a straight C₃-C₄₀-alkylene group, a branched C₃-C₄₀-alkylene group, a C₅-C₄₀-aryl group, or a combination thereof,
wherein urethane polymers comprising more than 3 residues of the compound (b) are a majority by number, measured by SEC.

2. The composition of claim 1, wherein:
the urethane polymers comprising more than three residues of the compound (b) are at least 40% by number, of all of the urethane polymers; or:
the urethane polymers have a molar mass Mw, measured by SEC, greater than 20,000 g/mol, or a molar mass Mw of less than 500,000 g/mol; or
the urethane polymers have a molar mass Mw, measured by SEC, in a range of from 20,000 g/mol to 500,000 g/mol; or
the urethane polymers have a polymolecularity index PI, measured by SEC, of less than 4; or have a PI greater than 1.3.

3. The composition of claim 1, wherein the diisocyanate compound (a) comprises
a symmetric aromatic diisocyanate compound;
a symmetric alicyclic diisocyanate compound;
a symmetric aliphatic diisocyanate compound;
an asymmetric aromatic diisocyanate compound; or
an asymmetric alicyclic diisocyanate compound.

4. The composition of claim 1, wherein the polyhydroxylated compound (b) is a compound of formula (II): 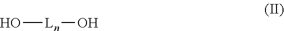
wherein:
L is independently an oxyalkylene residue; and
n is independently a number in a range of from 10 to 500.

5. The composition of claim 1, wherein the compound (b) has a molar mass (Mw), measured by SEC, in a range of from 800 to 15,000 g/mol.

6. The composition of claim 1, wherein, in the compound (c),
R is independently a straight C₁-C₃₂-alkyl group, a branched C₃-C₃₂-alkyl group, a C₅-C₃₂-cycloalkyl group, a straight C₃-C₃₂-alkylene group, a branched C₃-C₃₂-alkylene group, a C₅-C₃₂-aryl group, or a combination thereof.

7. The composition according to claim 1, in which the polymerisation reaction comprises:
the monomer (a) in a range of from 10 to 79.9 mol %, or
the monomer (b) in a range of from 20 to 89.9 mol %, or
the monomer (c) in a range of from 0.1 to 70 mol %, relative to a total molar amount of monomers (a), (b) and (c).

8. The composition of claim 1, wherein an (a)/(b) molar ratio of the diisocyanate compound (a) to the polyhydroxylated compound (b) in the polymerizing is in a range of from 1.05 to 3.

9. The composition of claim 1, wherein urethane polymers comprising more than 4 residues, of compound (b) are in the majority by number, measured by SEC.

10. A method of discontinuously preparing the composition C of claim 1, comprising:
polymerizing, in the absence of any monohydroxyl compound, monomers comprising a diisocyanate compound (a) and a polyhydroxylated compound (b);
followed by:
terminating the prepolymer of the compounds (a) and (b) with a terminator comprising a compound (c) of formula (I): 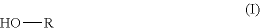
wherein R is independently a straight C₁-C₄₀-alkyl group, a branched C₃-C₄₀-alkyl group, a C₅-C₄₀-cycloalkyl group, a straight C₃-C₄₀-alkylene group, a branched C₃-C₄₀-alkylene group, a C₅-C₄₀-aryl group, or a combination and thereof, and
wherein urethane polymers strictly comprising more than 3 residues of the compound (b) are a majority by number, measured by SEC.

11. The method of claim 10, wherein in:
the polymerizing is carried out in the polyhydroxylated compound (b); or
the polymerizing comprises the diisocyanate compound (a) and the polyhydroxylated compound (b) in an (a)/(b) molar ratio in a range of from 1.05 to 3; or
the polymerizing is carried out for 10 to 60 minutes.

12. A urethane polymer P, prepared by the method of claim 10, the urethane polymer P comprising:
more than 3 of the compound (b).

13. An electrode preparation composition T, comprising:
a material E comprising:
an anode material E1 comprising a metal fiber, metal particle, carbon graphite fiber, carbon graphite particle, and/or a silicon particle;
a cathode material E2 comprising a carbon particle;
an electroactive cathode material E3;
a binding agent L suitable for the material E comprising the composition C of claim 1; and
a liquid carrier.

14. The composition T of claim 13, wherein:
the anode material E1 comprises silicon, carbon graphite, graphitic carbon, hexagonal carbon, and/or rhombohedral carbon, optionally doped with an element or
the anode material E1 is in the form of particles; or
the cathode material E2 comprises carbon black, acetylene black, Ketjen black, carbon fiber, carbon nanotube, carbon nanofiber, and/or graphene; or
the electroactive material E3 comprises is lithium, iron, nickel, manganese, and/or cobalt.

15. The composition T of claim 13, further comprising;
an anode binding polymer L1 in the form of a water-insoluble latex;
a water-soluble binding polymer anode L2;
an anode binding polymer L3 comprising cellulose;
a cathode binding agent L4 comprising polyvinylidene fluoride.

16. The composition T of claim 13, comprising:
the material E in a range of from 85 to 99.5% by dry weight;
the binding agent L in a range of from 0.5 to 15% by dry weight;
relative to the total amount by dry weight of binding agent and the material E.

17. A method for preparing the composition T of claim 13, comprising:
preparing the binding agent L; and adding the material E and the liquid carrier.

18. A method for producing an anode, comprising:
applying the anode composition T of claim 13 to a substrate, to form a coated substrate; and
drying and then calendering the coated substrate.

19. The method of claim 18, wherein:
the applying is carried out at a pH of less than 7, or
the anode composition T is applied to the substrate at a thickness, after drying and calendering, measured using a 1 μm to 1,000 μm coating thickness gauge, that is less than 500 μm, or
the anode composition T is applied to the substrate at a thickness, after drying and calendering, measured using a 1 μm to 1,000 μm coating thickness gauge, that is greater than 5 μm, or;
the anode composition T is uniformly applied to the substrate.

20. An anode, produced by the method of claim 18.

21. A method for producing a cathode, comprising:
applying the aqueous composition T of claim 13 to a metal substrate comprising aluminum,
drying and then calendering the metal substrate coated with the composition T.

22. The method of claim 21, wherein:
the substrate is a purely metallic substrate or a composite substrate comprising a metal and an insulating substrate; or
the electroactive compound comprises lithium, iron, nickel, manganese, and/or cobalt.

23. A cathode, produced by the method of claim 21.
